(19) United States
(12) Patent Application Publication
(10) Pub. No.: US 2012/0314728 A1
(43) Pub. Date: Dec. 13, 2012

(54) SYSTEM AND METHOD TO DELIVER AND CONTROL POWER TO AN ARC FURNACE

(75) Inventors: Souheil Benzerrouk, Hudson, NH (US); Christopher Carl Johnson, Concord, NH (US)

(73) Assignee: Warner Power LLC, Warner, NH (US)

(21) Appl. No.: 13/155,842

(22) Filed: Jun. 8, 2011

(51) Int. Cl. H05B 7/144

(52) U.S. Cl. 373/102

(57) ABSTRACT

A power supply system for an arc furnace includes a three phase transformer assembly, back to back SCRs coupled between a power source and the three phase transformer assembly primary windings, and three saturable-reactors, coupled between the three phase transformer assembly secondary windings and a load. A controlled DC current source is coupled between a system controller and each of said three saturable-reactors. The system controller is configured for monitoring the power source and an output current at the load, and for controlling the back-to-back SCRs and the current source.

### TECHNICAL FIELD

The present invention relates to electric arc furnaces and more particularly, relates to a power supply for such electric arc furnaces.

### BACKGROUND INFORMATION

Electric arc furnaces are widely used in the metal working industry and in other areas of manufacturing. These furnaces utilize, among other elements, electrodes to draw an electric arc which provide the heat for the furnace, and power systems to couple and control energy to the arc. There are two fundamental arc-furnaces; direct current, or alternating current, where the latter is the most commonly used in the industry due to its simplicity and ease of implementation. However, regardless of the type of arc furnace, the main challenge in designing a power supply capable of delivering the adequate energy to maintain the arc or re-ignite at each cycle reside in the dynamic, non-linear and chaotic nature of the load. Arcs are known to cause a multitude of problems to the power system as well as many performance limitations such as flicker effect, unbalance and harmonic currents. More severe or catastrophic outcomes are also common and are generally caused by instabilities in the control system and the inherent transients.

Current approaches to remedy these problems focus on filters to minimize the effects of flicker and harmonic distortion and feedback control to attempt to eliminate instability and control arc parameters with the intent of controlling manufacturing process. A thorough review of the techniques employed thus far shows that process control is not fully attained and most control algorithms fail to maintain a stable operation throughout the range of variation of the load. The most advanced control algorithms employ predictive and adaptive models for arc resistance and use passive elements to filter harmonics and limit flicker and instability.

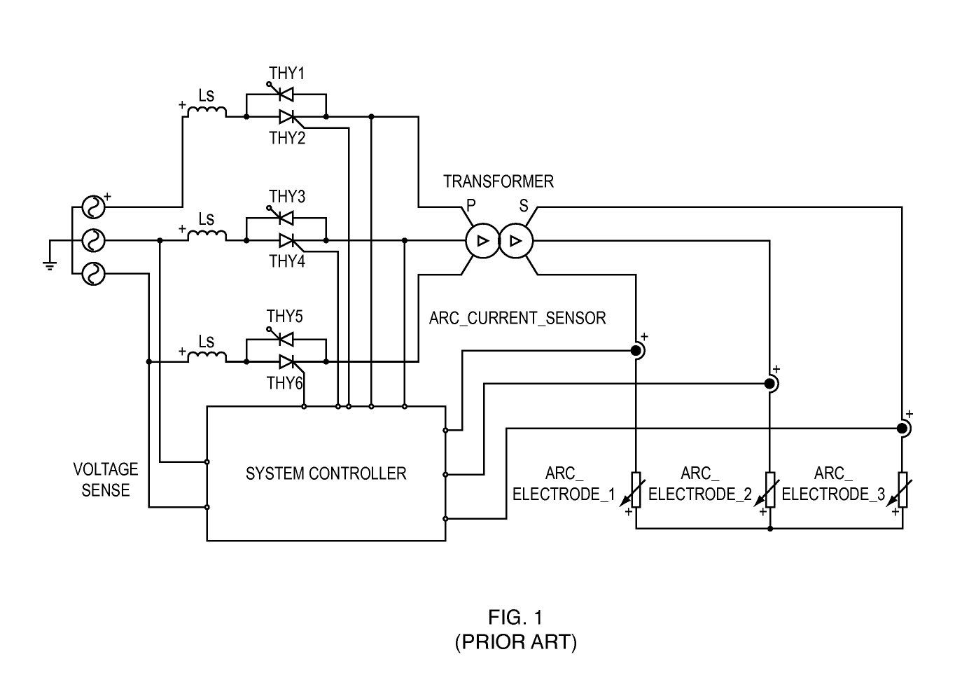

A typical AC arc furnace power supply is depicted in FIG. 1 where back to back SCRs (TH1 through TH6) are used to control one of either the output current and/or voltage depending on the application. Here current or voltage monitors feedback the output current or voltage to the system controller which through PI, PID control loops or adaptive models adjust the duty-cycle of the SRC. These systems and control methods suffer major drawbacks such as the non-ability to control current and voltage independently, which therefore limits the operating range and does not allow for a smooth arc ignition and turn-off thereby reducing the life of the electrodes. In addition to complex control, major filtering is required to manage flicker effects and harmonics.

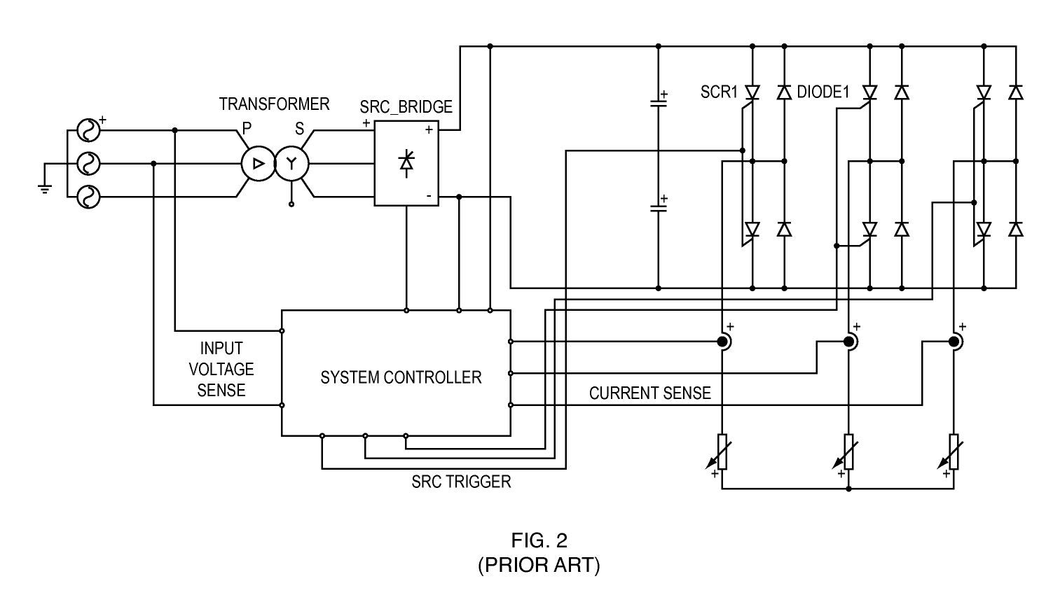

More advanced and newer topologies were devised to improve the performance as shown in FIG. 2 where a two stage topology is employed. The first stage is a AC/DC rectifier while the additional DC/AC stage helps invert the signal into AC with the possibility to control output current and the option of higher frequency operation. Such a topology allows the quasi decoupling of output current and voltage yet it adds complexity and cost. In addition to the complex control schemes, series reactors are added to smooth the current output and limit maximum current to a predertmined value. Such elements add a pole to the transfer function of the system which increase the possibility of oscillations.

Accordingly, what is needed is a power supply for an arc furnace that is capable of delivering the adequate energy to ignite the arc, maintain the arc or re-ignite at each cycle and to reduce or eliminate performance limitations such as flicker effect, unbalance, harmonic currents and oscillations.

### SUMMARY

The proposed approach is based on the idea of inserting a saturable-reactor in the output path between the transformer and the electrodes. This reactor is controlled through an external DC power source to control the permeability of the core of the reactor and therefore the series impedance. The saturable-reactor acts as a current limiting device that prevents damage to the electrodes and the input elements of the power supply and allows the decoupling of the control knobs for the arc such as current and voltage.

BRIEF DESCRIPTION DESCRIPTION OF THE DRAWINGS

These and other features and advantages of the present invention will be better understood by reading the following detailed description, taken together with the drawings wherein:

FIG. 1 is a schematic of a prior art power supply topology employed in AC arc furnaces;

FIG. 2 is a schematic of another prior art power supply topology employed in AC arc furnaces;

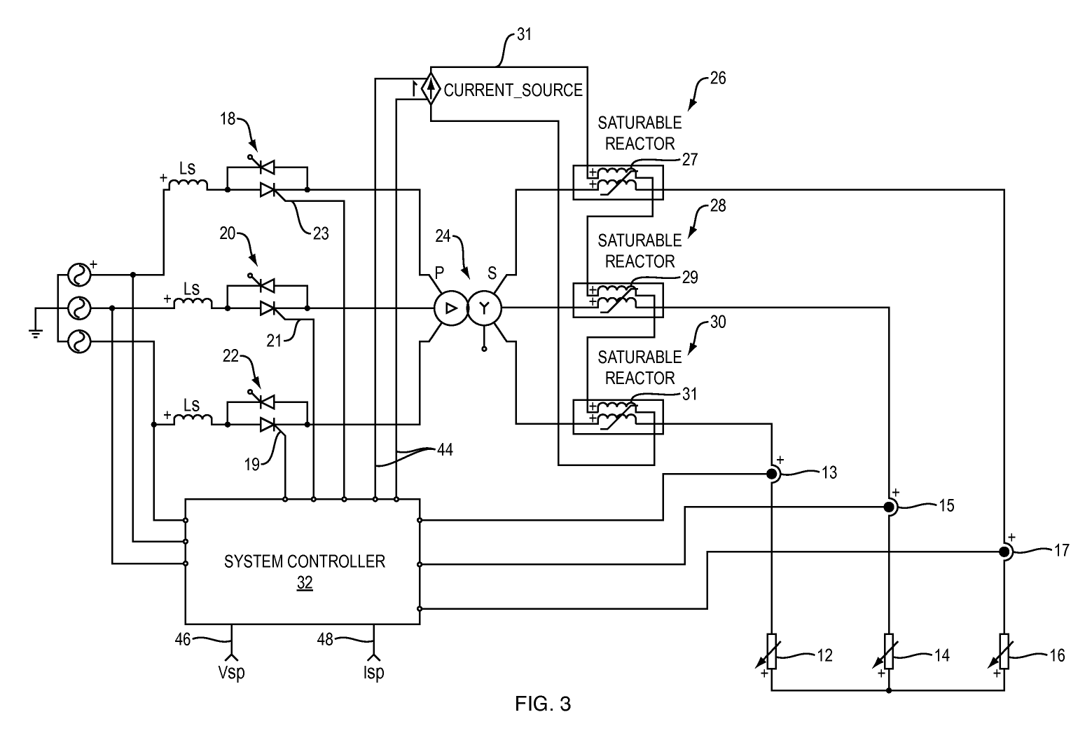

FIG. 3 is a schematic of the power supply topology employed in AC arc furnaces in accordance with the present invention;

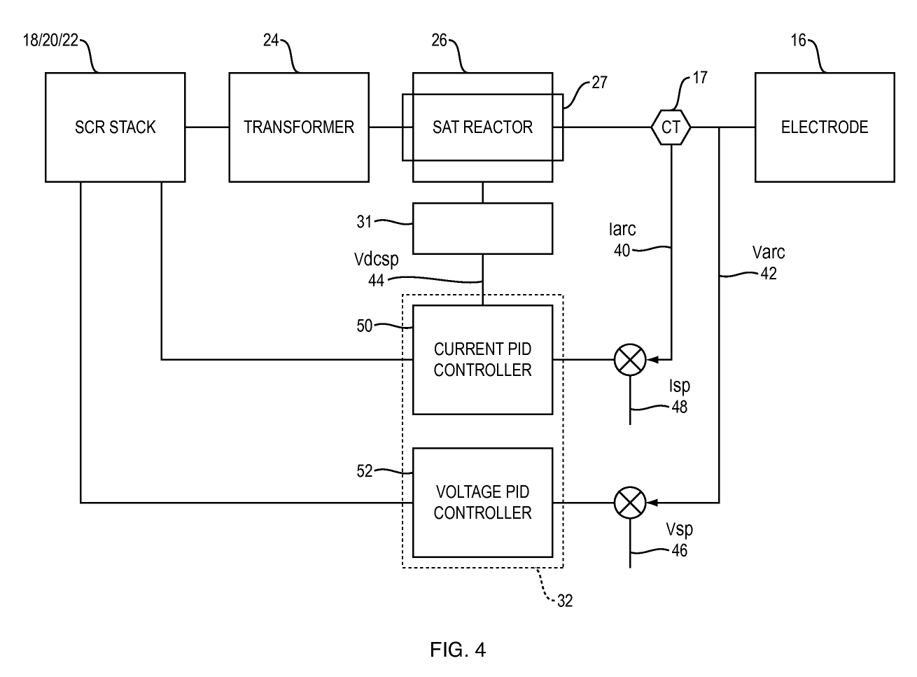

FIG. 4 is a schematic of one of the three phases of the system in accordance with the present invention;

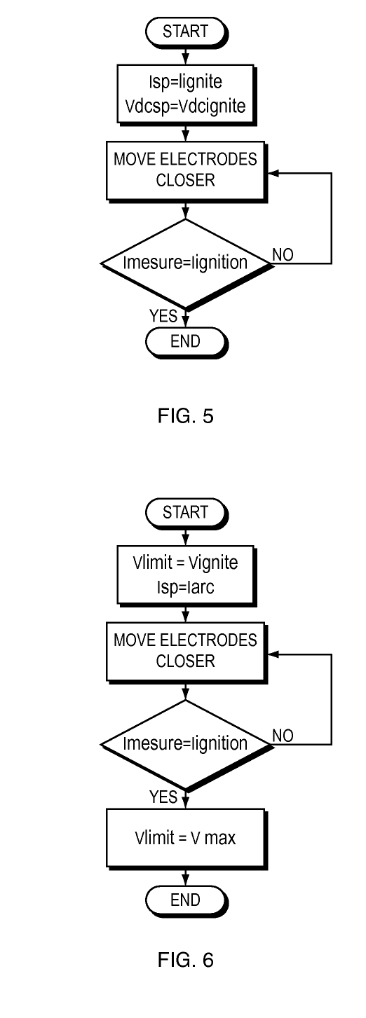

FIG. 5 is an ignition flow diagram that utilizes the saturable reactor to limit the ignition current according to one embodiment of the present invention;

FIG. 6 is an ignition flow diagram that utilizes the saturable reactor to limit the ignition current according to one embodiment of the present invention;

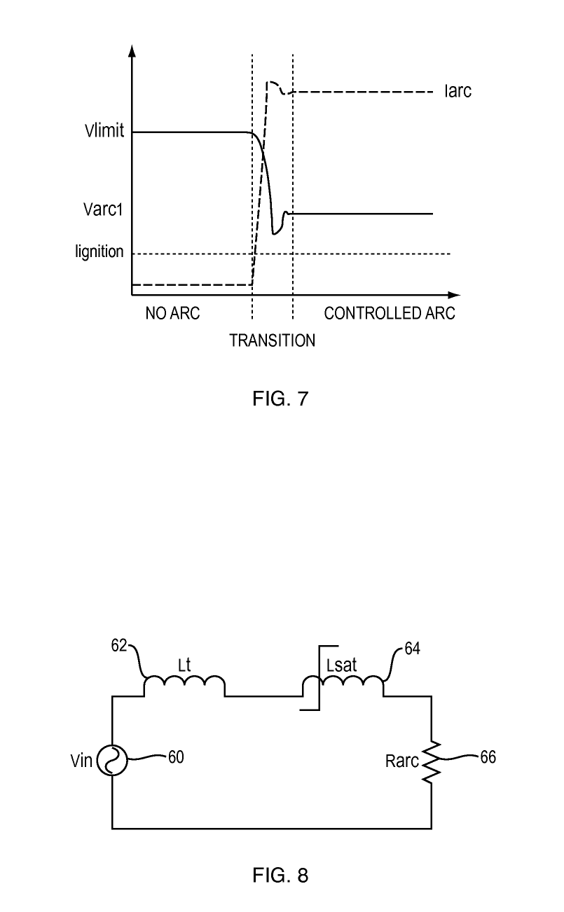

FIG. 7 is a graph that illustrates ignition phases and arc parameters according to one embodiment of the present invention;

FIG. 8 is a schematic of a simplified circuit diagram of a single phase of the present invention;

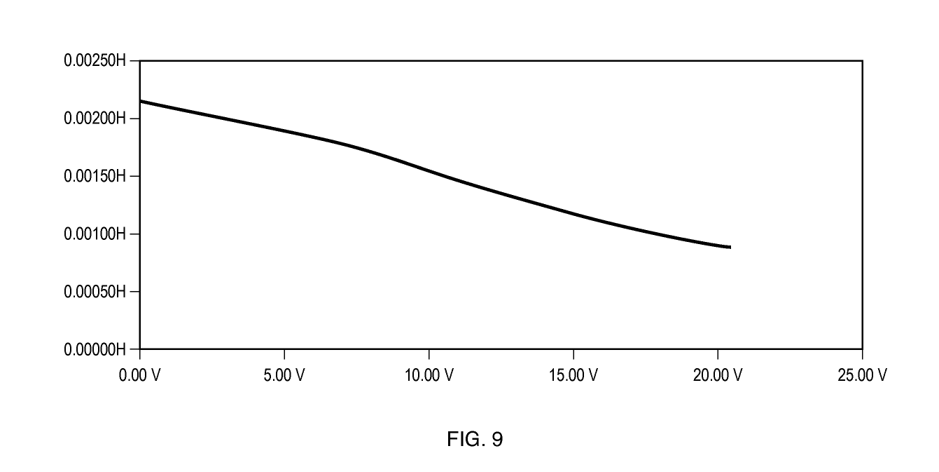

FIG. 9 is a graph illustrating how in a test environment the inductance of the saturable reactor varies with the applied DC control voltage; and

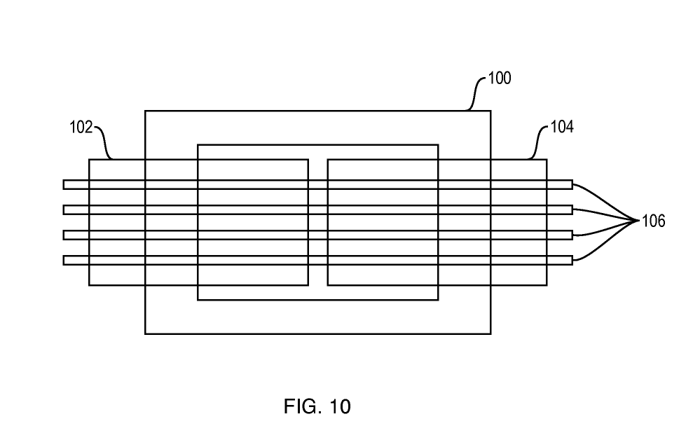

FIG. 10 is a front cross-sectional view of one construction technique of a saturable reactor according to the present invention.

### DETAILED DESCRIPTION OF THE PREFERRED EMBODIMENTS

This system can be constructed with several embodiments based on the application and control requirements. As shown in FIG. 3, output voltage at points 12, 14 and 16 is controlled by adjusting the duty-cycle of the SCRs 18, 20 and 22. An SCR, or Silicon Controlled Rectifier, is a power semiconductor that allows the control of a large current or voltage using a small control current. Basically, it is a simple direct (DC) or alternating (AC) current light switch. For example, if you place an available current on the cathode, a load on the anode, you can switch the current on by applying a small control current to the gate 19, 21 and 23, which control current is supplied by the system controller 32.

SCR's will block reverse current polarity and only allow correct polarity, and accordingly, two SCR's back-to-back are required for an AC circuit. One SCR will control current in one direction and the other in the opposite polarity. Accordingly, when referring to SCRs in this discussion, it means an SCR “stack” comprising of 2 back-to-back SCRs.

The SCRs 18-23 maybe located in the primary side of the transformer 24 as shown in FIG. 3 or on the secondary side of the transformer (not shown but well known in the art). The SCRs serve to limit the in-rush start-up current through the power supply; limit the in-use current drawn by the electrodes 12, 14 and 16; and allow for control of the output current to the electrodes as measured by current measuring devices 13, 15 and 17. An example of an SCR that can be used in this invention is a 600V, 1300-1500 Amp SCR.

The output current to the electrodes 12, 14 and 16 is controlled and modified by adjusting the DC current through the saturable-reactors 26, 28 and 30, allowing the decoupling or separating of control inputs for voltage (controlled by the SCRs) and current (controlled by the saturable reactors) while providing a power supply system that is able to control both voltage and current independently.

A saturable reactor is a special form of inductor where the magnetic core can be deliberately saturated by means of a dc current flowing in a control winding.

As shown in FIG. 9, once saturated, the inductance of the saturable reactor 26, 28, 30 drops dramatically. A saturable reactor 26, for example, as shown in cross-section in FIG. 10, includes a magnetic steel iron-core 100 around each leg of which is provided coil A (102) and coil B (104). The inductance control of the saturable reactor is achieved by providing a DC current through a length of copper wire 106 wound around the coils 102 and 104 forming the saturation windings 27, 29 and 31. The inductance of the saturable reactor 26, 28, 30 may be changed by varying the permeability (saturation) of the core using the DC current provided through the wire 106 forming the saturation windings 27, 29 and 31, and is used to control large alternating currents.

Output parameter such as voltage is controlled/modified by adjusting the firing angle (or duty cycle) of the SCRs 18, 20 and 22. By introducing the saturable reactors 26, 28 and 30, the controller 32 of present invention is able to control current provided by the DC power supply 31 driving the saturation windings 27, 29 and 31 of the saturable reactors 26, 28 and 30, and thereby control current to the electrodes through the entire operating range of the SCRs. The SCRs control one parameter while the saturable reactors control the other parameter. Saturable reactors are well known in the art and are available, for example, from Warner Power, the assignee of the present invention.

Arc initiation and turn-off follows a sequence that guarantees soft current/voltage transitions. Soft transitions are related to the change in current over time (di/dt) and change in voltage (dV/dt). The term is also used to imply the suppression of voltage and current spikes. Typically when the arc is initiated current transitions from 0 or a few tens of amps to more than a thousand amps in less than a milli-second, by introducing and controlling the saturable reactor we can control the rate of change and the final value for the current.

The invention includes, in one embodiment, a closed loop system where the system controller 32 adjusts the output current and voltage utilizing a control algorithm which measures or monitors certain output parameters and uses those readings to adjust arc performance and parameters such as arc energy, output power and/or output current. The power supply becomes a closed loop system that maintains a desired voltage, current or power. The power supply utilizes one or more set points from the system controller 32 to ultimately achieve a certain process performance. Among the performance requirements is a specific arc energy, power or temperature, for example.

The present invention also features, in another embodiment, an open loop system such that the output parameters are regulated in response to a change in a voltage or current set-point 46, 48 set by the user or the system controller 32 or a preprogrammed recipe or algorithm. This system is considered open loop because output parameters are not monitored and used to maintain regulation. However, for equipment safety these parameters are adjusted in a turn-on/turnoff sequence and may be limited so that no excessive voltage or current condition occurs.

One of the three phases of the system is shown in FIG. 4. Iarc 40 and Varc 42 are the measured arc parameters of current and voltage respectively, while VDCSP 44 is the direct current control signal provided to the DC current ource 31 which in turn establishes the amount of DC current in the saturation coil 27 in the saturable reactor 26 to adjust Lsat (saturation inductance) to the desired value.

The transformer 24 is preferably a 500 KVA single phase, 2:1 step down transformer such that three of such devices can handle a total power of 1500 KVA and three phases. The SCRs 18/20/22 are rated at 600 volts and 1300-1500 A since they are located in the primary side of the transformer. Locating the SCRs 18/20/22 in the secondary side will require larger devices i.e. a minimum of 3000 A and may require transient suppression to eliminate potential voltage spikes that can occur when the arc extinguishes.

The system controller 32 includes the functions of both a current PID controller 50 and a voltage PID controller 52. A proportional-integral-derivative controller (PID controller) is a generic control loop feedback mechanism (controller) widely used in industrial control systems. A PID controller calculates an “error” value as the difference between a measured process of variable and a desired set point. The controller attempts to minimize the error by adjusting the process control inputs.

The PID controller calculation (algorithm) involves three separate constant parameters and is accordingly sometimes called three-term control: the proportional, the integral and derivative values, denoted P, I, and D. Heuristically, these values can be interpreted in terms of time: P depends on the present error, I on the accumulation of past errors, and D is a prediction of future errors, based on current rate of change. The weighted sum of these three actions is used to adjust the process via a control element such as the position of a control valve or the power supply of a heating element.

The proportional term P adjusts for any difference between a user input voltage setpoint Vsp 46 or current setpoint Isp 48 and the actual voltage measurement on the electrode Varc 42, and the actual current measurement through the electrode Iarc 40, while the intergral term I corrects for changes over time.

A typical PI control transfer function may be written as follows:

$$H ( s ) = {K}_{p} ( 1 + \frac{1}{{T}_{I} s} ) . \qquad Eq . 1$$

With Kₚ representing the proportional gain and T_{I} the intergral time. These parameters have to be tuned with the system to include all system dynamics to meet the step change requirements and limited potential overshoot after a step change in the setpoint.

Ignition is known to be the phase where electrodes see the most stress due to the large amount of energy that is dissipated in the arc abruptly. In many instances if no limiting element is available, the electrodes are destroyed. In addition to the requirement for a smooth ignition, a conflicting requirement exists in sustaining the arc after its formation. These two phases require another set of voltage and current requirements with a minimum transition time. The saturable reactors (26, 28 and 30) in this case will provide the ability to limit ignition current when the voltage is at maximum then quickly allow the desired current to flow in the system as shown in the ignition flow diagrams, FIGS. 5 and 6. The ignition phases and arc parameters are shown in FIG. 7.

The saturable reactors 26/28/30 are designed to cover at least a range that allows Iarc min. to Iarc max which are determined using the model shown in FIG. 5. The schematics of an equivalent circuit model for a single phase is shown in FIG. 8, including Vin 60, Lt 62, Lsat 64 and Rarc 66.

$${I}_{arcmax} = \frac{{V}_{in} - {V}_{arc}}{2 π f {L}_{sat}} = \frac{{V}_{arc}}{{R}_{arc , min}} \qquad Eq . 2$$

### Therefore:

$${L}_{sat} = \frac{{V}_{in} - {I}_{arcmax} {R}_{arc , min .}}{2 π f {I}_{arcmax}} ≅ 234 µH \\ At {I}_{arcmax} = 2500 A and {R}_{arc , min .} = 50 m Ω \qquad Eq . 3$$

Furthermore, the sat reactor 64 is designed to have an inductance capable of limiting maximum current at ignition even if the electrodes touch. This imposes a minimum inductance for the sat reactor when the saturation coil (DC coil) is not excited.

$${L}_{sat , reactor} \geq \frac{{V}_{in}}{2 π f {I}_{ignition}} ≅ 1.8 mH \qquad Eq . 4$$

For I_{ignition}=500 A

The physical design of the saturable reactor is preferably accomplished using M5 steel with a distributed gap. FIG. 10 depicts a 500 KVA Sat reactor. The Sat Reactor also uses two parallel connected windings 102, 104 to handle both half cycles and in turn guarantee balanced operation.

The present invention thus provides a system where three independent DC power supplies are utilized to allow for the independent control of output current to each electrode is also contemplated and disclosed. This may be very useful and improves system performance in the case where the electrodes can move independently and spatial and angular symmetry is not guaranteed. In this situation, an arc can form between two electrodes only (instead of three). This specific situation may lead to a major unbalance in the system.

Accordingly, the present invention provides a novel and useful power supply for an arc furnace that is capable of delivering the adequate energy to ignite the arc, maintain the arc or re-ignite at each cycle and to reduce or eliminate performance limitations such as flicker effect, unbalance, harmonic currents and oscillations.

Modifications and substitutions by one of ordinary skill in the art are considered to be within the scope of the present invention, which is not to be limited except by the allowed claims and their legal equivalents.

The invention featured is:

1. A power supply system for an arc furnace, the power supply comprising:
a three-phase transformer assembly, said three-phase transformer assembly including three primary windings, each of said three primary windings configured for coupling to one source and phase of a three phase input power, said three-phase transformer assembly including three secondary windings, each of said secondary windings configured for coupling to a load;
three Silicon Controlled Rectifier (SCR) stacks, each of said three SCR stacks including two back-to-back SCRs coupled between one source and phase of said three phase input power sources and one of said transformer primary windings, each of said three SCR stackss responsive to an SCR control signal, for controlling the application of power from said one source and phase of three phase input power to one transformer primary winding;
three saturable-reactors, each of said three saturable-reactors coupled between one of said three-phase transformer secondary windings and a load, each of said three saturable-reactors responsive to a DC current control signal, and responsive to a level of said DC current control signal, for providing an inductance between said three transformer secondary windings and a load that is variable based upon said level of said DC current control signal, for controlling a current applied to each respective said loads;
at least one controlled DC current source, coupled between a system controller and each of said three saturable-reactors, and responsive to a DC current source control signal, for controlling said level of said DC current control signal applied to each said three saturable-reactors; and
a system controller, responsive to a control algorithm, for providing said SCR control signals to each said three SCR stackss and for providing said DC current source control signal which in turn controls said level of said DC current control signal applied to each said three saturable-reactors.

2. The power supply system of claim 1, wherein said transformer assembly is selected from the group consisting of a single three phase transformer and three, single phase transformers.

3. The power supply system of claim 1, wherein said system controller is configured for monitoring at least one of said three phase input power source, an output current and an output voltage, and responsive to said monitoring, for controlling said SCR control signals to each said three SCR stackss and for providing said DC current source control signal which in turn controls said level of said DC current control signal applied to each said three saturable-reactors.

4. The power supply system of claim 1, wherein said three saturable reactors include a saturation control winding.

5. The power supply system of claim 4, wherein said output current supplied to said load is controlled by adjusting the level of said DC current control signal applied to each saturation control winding of each of said three saturable-reactors.

6. The power supply system of claim 1, wherein said at least one controlled DC current source includes three controlled DC current sources, one for each of said three saturable reactors.

7. The power supply system of claim 1, wherein said system controller, responsive to a control algorithm, controls an output voltage to said loads by adjusting said SCR control signals to each said three SCRs thereby adjusting the duty cycle of said SCR stacks.

8. The power supply system of claim 1, wherein power supply parameters such as energy, power, current and/or voltage are modified and controlled through the modification of either output current, output voltage or both.

9. The power supply system of claim 1, wherein said control algorithm for said system controller includes a sequence that guarantees a predetermined change of rate for current to the load.

10. The power supply system claim 1, wherein said control algorithm includes a turn-off sequence wherein said turn off sequence:
(a) causes said system controller to lower said DC current source control signal which in turn lowers said level of said DC current control signal applied to each said three saturable-reactors; and
(b) causes said system controller to lower the output voltage by adjusting the duty cycle to a minimum by adjusting said SCR control signals to each said three SCR stacks thereby adjusting the duty cycle of said SCR stacks until the arc extinguishes whereby after arc extinction, the electrodes can be moved apart.

11. The power supply system claim 1, wherein said control algorithm includes a turn-on sequence, wherein said turn on sequence:
(a) causes said system controller to lower said DC current source control signal which in turn lowers said level of said DC current control signal applied to each said three saturable-reactors thereby increasing the inductance of the saturable reactor to a maximum; and
(b) once the arc has ignited, said turn on sequence causes said system controller to adjust said DC current control signal whereby a saturation point of the saturable reactors is adjusted to allow the flow of a desired amount of current.
